(19) United States
(12) Patent Application Publication
(10) Pub. No.: US 2001/0003035 A1
(43) Pub. Date: Jun. 7, 2001

(54) DIFFRACTION GRATING AND FABRICATION TECHNIQUE FOR SAME

(76) Inventors: ROBERT G. OZARSKI, POWAY, CA (US); JOHN L. CROWLEY, DAYTON, NV (US)

Correspondence Address: JOHN R ROSS, CYMER INC, 16750 VIA DEL CAMPO COURT, SAN DIEGO, CA, 921271712

(21) Appl. No.: 09/151,128

(22) Filed: Sep. 10, 1998

(51) Int. Cl. G02B 5/18

(52) U.S. Cl. 430/321; 264/1.31; 264/2.5; 359/571; 359/566

(57) ABSTRACT

Large, high quality diffraction gratings having carefully formed blazing angles and defect free reflective surfaces can be fabricated on specially oriented substrates using photolithographic or micromachining techniques. By selecting a single crystal substrate whose surface is at a known angle with respect to certain crystallographic planes of the substrate, anisotropic etching of the substrate can achieve diffraction grating grooves with reflective surfaces corresponding to the to specific crystallographic planes. The angle between the surface of the substrate and the specific crystallographic planes determines the blazing angle of the diffraction grating. Thus, large, high quality diffraction gratings can be fabricated for use in, for example, laser systems, or for use as master gratings in the manufacture of replica gratings.

### BACKGROUND OF THE INVENTION

1. Field of the Invention

This invention relates to diffraction gratings and particularly to diffraction gratings fabricated by photolithographic techniques.

2. Description of the Related Art

Lasers have numerous applications in, for example, research, development, manufacturing, medicine, communications, and consumer products. In many of these applications, one of the advantages of using a laser is that it produces substantially monochromatic light. For example, lasers are used in deep-ultraviolet (DUV) (approximately 180-280 nm) photolithography for integrated circuit fabrication, thereby permitting smaller structures to be created by exploiting the laser's shorter wavelengths. Excimer lasers producing laser light at approximately 248 nm are employed in exposing photoresistive masks used in integrated circuit fabrication. When lasers are used in photolithography, it is desirable that the wavelength band of the light from the laser be relatively narrow so as to minimize changes in wavelength which adversely affect focusing of the light on masking layers, thereby affecting the quality and sharpness of photolithographic features.

One of the most common techniques for accomplishing spectral narrowing in lasers is to use a diffraction grating either as part of the laser cavity itself, or to separate or filter out specific desirable or undesirable wavelengths. Of all the different types of diffraction gratings, echelle gratings, or echelles, are particularly useful for spectral narrowing in excimer lasers. Generally, echelles are coarse but precisely ruled gratings used at high angles of diffraction and in high spectral orders. Typical groove frequencies are 316 grooves/mm or less. Among the special properties of echelles are high dispersion leading to compact optical systems with high throughput, high resolution for a given size grating, and damage resistance. Moreover, because they are seldom used far from the blaze direction, their efficiency remains relatively high over a large spectral range. FIG. 1 shows a cross-section of an echelle grating in the Littrow configuration. Grating 100 includes parallel grooves 110, each with two facets and having a groove spacing d. Facet 120 is located at a blaze angle θ with respect to the plane of the grating. When the angle of incidence α is equal to the diffraction angle β and the blaze angle θ, incident light 130 is diffracted in a given diffracted order 140 (i.e. the m-th order) which propagates backward toward the source. This Littrow configuration corresponds to maximum efficiency of diffraction and is described by the equation:

$$2 sin α = m \frac{λ}{d} ,$$

where λ is the wavelength of the incident light. For example, a preferred echelle for use in an excimer laser at approximately λ=248 nm and with α=β=θ=78.81° will have a groove spacing of d=10 μm for the m=79 order diffracted beam.

Another characteristic of an echelle is its free spectral range (FSR), given by λ/m, which is the range of wavelengths for which overlapping from adjacent orders (e.g. the m and m+1 orders) does not occur. Thus, in the example above, the echelle will have an FSR of approximately 3.14 nm. Free spectral range is a concept particularly important for echelles because they operate in high orders with corresponding short free spectral range.

Resolution is another important property of echelles indicating the grating's ability to separate adjacent spectral lines (e.g. in spectroscopy of a light source or within the gain profile of a laser). For a grating mounted in the Littrow configuration, the resolution R is given by:

$$R = \frac{λ}{Δ λ} = \frac{2 W}{λ} sin θ ,$$

where W is the groove spacing d times the number of grooves M, that is W is the width of the grating. Given this relationship, it is clear that very wide gratings are required if high resolution is to be achieved.

One traditional method of manufacturing diffraction gratings, and particularly echelles, is to scribe or rule a series of grooves with a ruling engine on a good optical surface, such as a thin layer of aluminum or gold deposited on a suitable substrate. However, there are a number of difficulties associated with ruling gratings. Echelles are considered to be among the most difficult gratings to rule because high diffraction angles require exceptional ruling accuracy, yet this must be accomplished under high tool loads that usually accompany coarse groove spacing. The grooves must consistently have a uniform and correct shape to ensure high efficiency. Use at high diffraction orders requires blaze faces to be flat to nanometer tolerances if peak diffracted energy is to be concentrated in one blaze order. The grooves must also be ruled in a parallel and evenly spaced fashion because the density of grooves (e.g. grooves/mm) determines the dispersion and the accuracy in the position of the grooves determines the quality of the spectral image. Additionally, echelles typically have grooves that are deeper than other diffraction gratings (e.g. because of larger blazing angles) which in turn requires thicker metallic coatings consequently effecting the uniformity of the echelles flatness. Ruling engines used to fabricate echelles in this manner are complex mechanical devices that are slow and difficult to use, leading to gratings that are very expensive with long fabrication turnaround times.

Another technique produces so-called holographic gratings. An interference pattern created by two monochromatic, coherent laser beams is used to expose a photoresist film on a substrate. After exposure, the photoresist is developed and the substrate is etched. Although holographic gratings are relatively easy to manufacture, etching the desired blazing angle in such a grating is not, and fabricating high quality holographic gratings whose dimensions exceed 100 mm is very difficult.

Accordingly, it is desirable to have large, high quality diffraction gratings, and particularly echelles, that are relatively easy to fabricate and can be fabricated quickly and inexpensively compared to traditional grating fabrication methods.

### SUMMARY OF THE INVENTION

It has been discovered that large, high quality diffraction gratings having carefully formed blazing angles and defect free reflective surfaces can be fabricated on specially oriented substrates using photolithographic or micromachining techniques. By selecting a single crystal substrate whose surface is at a known angle with respect to certain crystallographic planes of the substrate, anisotropic etching of the substrate can achieve diffraction grating grooves with reflective surfaces corresponding to the to specific crystallographic planes. The angle between the surface of the substrate and the specific crystallographic planes determines the blazing angle of the diffraction grating. Thus, large, high quality diffraction gratings can be fabricated for use in, for example, laser systems, or for use as master gratings in the manufacture of replica gratings.

Accordingly, one aspect of the present invention provides an echelle including a single crystal substrate having a surface and a plurality of substantially parallel grooves formed in the substrate. Each groove includes a first facet substantially coplanar with a first crystallographic plane of the substrate and a second facet aparallel to the first facet and substantially coplanar with a second crystallographic plane of the substrate. The diffraction grating has a blaze angle defined by the surface of the substrate and the first facet.

Another aspect of the invention provides a replica diffraction grating. The replica diffraction grating includes a substrate and a resin layer disposed on a surface of the substrate. The resin layer includes a first plurality of substantially parallel grooves formed by contact with a master diffraction grating. The master diffraction grating includes a single crystal substrate having a surface and a plurality of substantially parallel grooves formed in the substrate. Each groove has a first facet substantially coplanar with a first crystallographic plane of the substrate and a second facet aparallel to the first facet and substantially coplanar with a second crystallographic plane of the substrate. The master diffraction grating has a blaze angle defined by the surface of the substrate and the first facet.

In still another aspect of the invention, a method of fabricating a diffraction grating is disclosed. A single crystal substrate including a top surface is provided. The top surface is oriented with respect to a first crystallographic plane of the substrate so as to define a blaze angle there between. A photoresist layer is deposited on the substrate. The photoresist layer is exposed and developed to form a plurality of substantially parallel mask features. The substrate is preferentially etched with a first etchant along a third crystallographic plane to form a plurality of grooves, each groove formed between two adjacent mask features and having a first facet and a second facet, the first facet being substantially coplanar with the first crystallographic plane and the second facet being substantially coplanar with a second crystallographic plane. The mask features are removed.

In still another aspect of the invention, a method of fabricating a replica diffraction grating is disclosed. A master diffraction grating is provided. The master diffraction grating includes a single crystal substrate having a surface and a plurality of substantially parallel grooves formed in the substrate. Each groove has a first facet substantially coplanar with a first crystallographic plane of the substrate and a second facet aparallel to the first facet and substantially coplanar with a second crystallographic plane of the substrate. The master diffraction grating has a blaze angle defined by the surface of the substrate and the first facet. The master diffraction grating is coated with a resin layer. A replica substrate is bonded to the resin layer. The master diffraction grating is separated from the resin layer and substrate.

In another aspect of the invention, an apparatus includes a light source and a replica diffraction grating located to receive light from the light source and reflect a particular range of wavelengths of the light from the light source. The replica diffraction grating includes a substrate and a resin layer disposed on a surface of the substrate. The resin layer includes a first plurality of substantially parallel grooves formed by contact with a master diffraction grating. The master diffraction grating includes a single crystal substrate having a surface and a plurality of substantially parallel grooves formed in the substrate. Each groove has a first facet substantially coplanar with a first crystallographic plane of the substrate and a second facet aparallel to the first facet and substantially coplanar with a second crystallographic plane of the substrate. The master diffraction grating has a blaze angle defined by the surface of the substrate and the first facet.

In still another aspect of the invention, an apparatus includes a light source and an echelle located to receive light from the light source and reflect a particular range of wavelengths of the light from the light source. The echelle includes a single crystal substrate having a surface and a plurality of substantially parallel grooves formed in the substrate. Each groove includes a first facet substantially coplanar with a first crystallographic plane of the substrate and a second facet aparallel to the first facet and substantially coplanar with a second crystallographic plane of the substrate. The diffraction grating has a blaze angle defined by the surface of the substrate and the first facet.

Yet another aspect of the invention provides a method for fabricating a replica diffraction grating. A stamper with a grating surface is formed from a master diffraction grating. The master diffraction grating includes a single crystal substrate having a surface and a plurality of substantially parallel grooves formed in the substrate. Each groove has a first facet substantially coplanar with a first crystallographic plane of the substrate and a second facet aparallel to the first facet and substantially coplanar with a second crystallographic plane of the substrate. The master diffraction grating has a blaze angle defined by the surface of the substrate and the first facet. The stamper is disposed in a mold such that the grating surface is an inner surface of the mold. The mold is filled with a liquid plastic. A molded replica diffraction grating is removed from the stamper.

Several advantages are attained by the described diffraction gratings and diffraction grating fabrication methods. Large gratings can be manufactured using large substrates, including, for example, 300 mm diameter silicon wafers. Still larger gratings can be manufactured by combining multiple gratings. Gratings can be quickly and inexpensively produced such that each grating used in an application can be a master grating, i.e. a grating produced by photolithographic techniques and not manufactured by making a replica of another grating. Replica gratings can be manufactured from master gratings so as to minimize any defects in the master grating, such as defects caused by masks used in etching. Precise control of the grating can be achieved by careful reticle fabrication, for which a variety of techniques exist including e-beam writing, optical beam writing, and ion beam writing.

### BRIEF DESCRIPTION OF THE DRAWINGS

The present invention may be better understood, and its numerous objects, features, and advantages made apparent to those skilled in the art by referencing the accompanying drawings.

FIG. 1 shows the geometry of an echelle grating in a Littrow configuration.

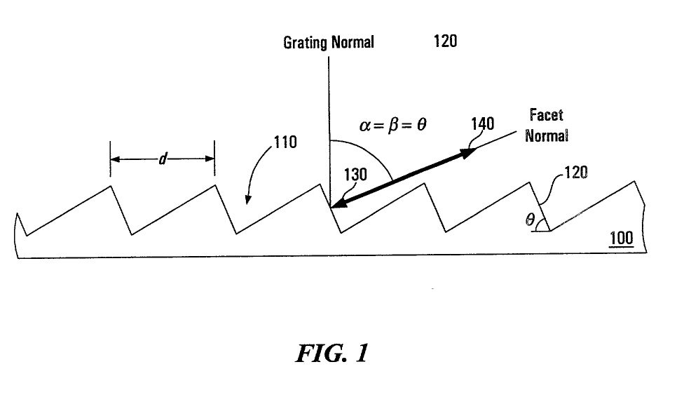

FIG. 2 illustrates how the substrate for a diffraction grating is cut from a boule of silicon.

FIGS. 3A-3E show cross-sectional views of the diffraction grating at various points in the diffraction grating fabrication process.

FIGS. 4A-4E show cross-sectional views of a replica diffraction grating formed from the diffraction grating of FIGS. 3A-3E or a similar diffraction grating.

FIGS. 5A-5C show cross-sectional views of another replica diffraction grating formed from the diffraction grating of FIGS. 3A-3E or a similar diffraction grating.

FIG. 6 is a schematic diagram of a laser system including a diffraction grating of the present invention.

### DETAILED DESCRIPTION

Micromachining or photolithographic fabrication often relies on etching techniques to selectively remove material in order to achieve the desired structure. In general, etching techniques are either isotropic, exhibiting the same etching characteristics in all directions, or anisotropic, thus having different etching characteristics (e.g. etch rate) in different directions. Additionally, etching techniques are generally either wet, where liquid solvents are used to perform the etching, or dry, where, for example, gas or plasma is used to remove material. In the case of silicon etching, both single crystal silicon and polycrystalline silicon can be wet etched in mixtures of nitric acid (HNO₃) and hydrofluoric acid (HF), and the mixture compositions can be varied to yield different etch rates. HF can also be used to etch silicon dioxide layers formed in or on single crystal silicon.

In some applications, for example fabricating a grating with a desired blaze angle, it is useful to etch silicon more rapidly along some crystal planes than others. This anisotropic etching allows the etch to significantly slow down or to etch specific shapes or structures in the silicon. In the diamond lattice of silicon, the (111) plane (or its equivalents generally designated as {111} planes) is more densely packed than the (100) plane. Consequently, etch rates of (111) oriented surfaces are expected to be lower than those of with (100) orientations. One common anisotropic wet etchant for silicon is a mixture of potassium hydroxide (KOH) and isopropyl alcohol. The etch rate of this etchant is about 100 times faster along (100) planes than along (111) planes.

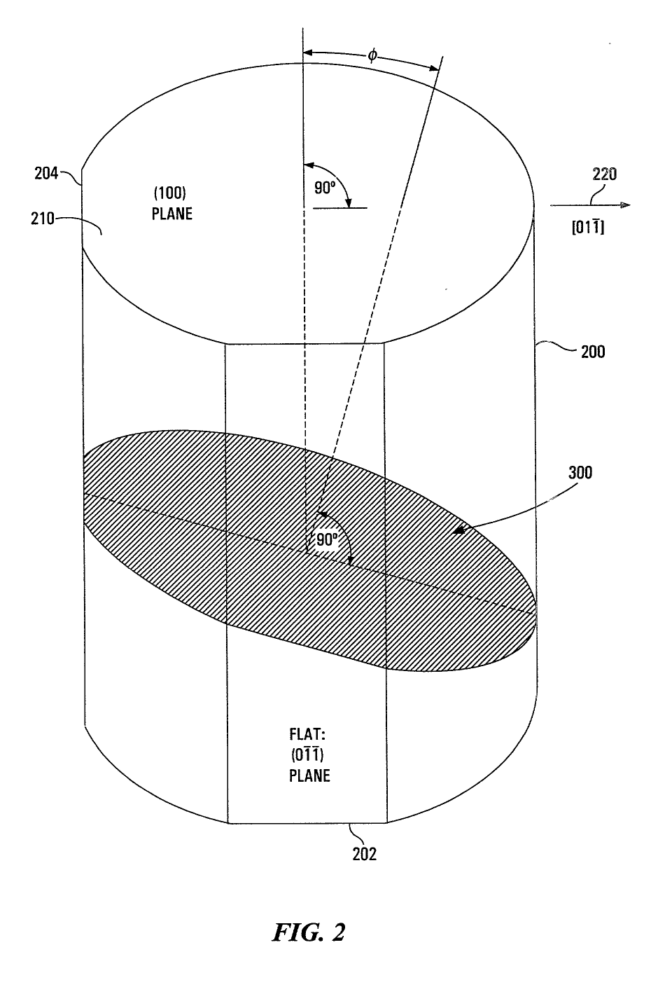

In order to etch a diffraction grating with grooves whose facets are at a desired angle with respect to each other, a single crystal substrate must be carefully chosen keeping in mind both the relative angles of the crystallographic planes of the single crystal substrate, and the orientation of those planes with respect to the plane of the diffraction grating, for example the plane of the substrate. FIG. 2 shows a boule of single crystal silicon 200. High purity, single crystal silicon is grown using a variety of techniques including the Czochralski method and the floating zone method. Additionally, single crystal silicon is grown in a variety of orientations depending on the desired application. Silicon boule 200 is grown with the (100) plane perpendicular to the length of the boule (i.e., the direction of growth), an orientation common in semiconductor manufacturing. Consequently, wafers sawn from the boule perpendicular to the growth axis has a surface with the (100) orientation. Silicon boule 200 includes flats 202 and 204 which are formed in the boule, by, for example, grinding, to help indicate the crystallographic axes of the silicon. In order to take advantage of the anisotropic etching of the {111} planes as noted above, a wafer to be etched should be cut from the boule at an angle φ with respect to the normal of the (100) plane, so that subsequent etching yields the desired angular grating groove facet features. For example, in order to fabricate a grating groove facet at an angle of 78.81° with respect to the plane or surface of the substrate wafer (i.e. the grating's blaze angle) and using anisotropic etching, the substrate wafer should be cut from the boule so that the angle between the surface and one of the {111} planes is 78.81°. Thus, substrate 300 is cut from boule 200 at an angle φ=24.07° (because the (111) plane forms an angle of 54.74° with the (100) plane) with respect to the normal of the (100) plane and in the direction shown by arrow 220. Substrate 300 then receives conventional wafer manufacturing processes including polishing both sides to provide thickness uniformity and flatness (e.g. a flatness of less than 5 μm).

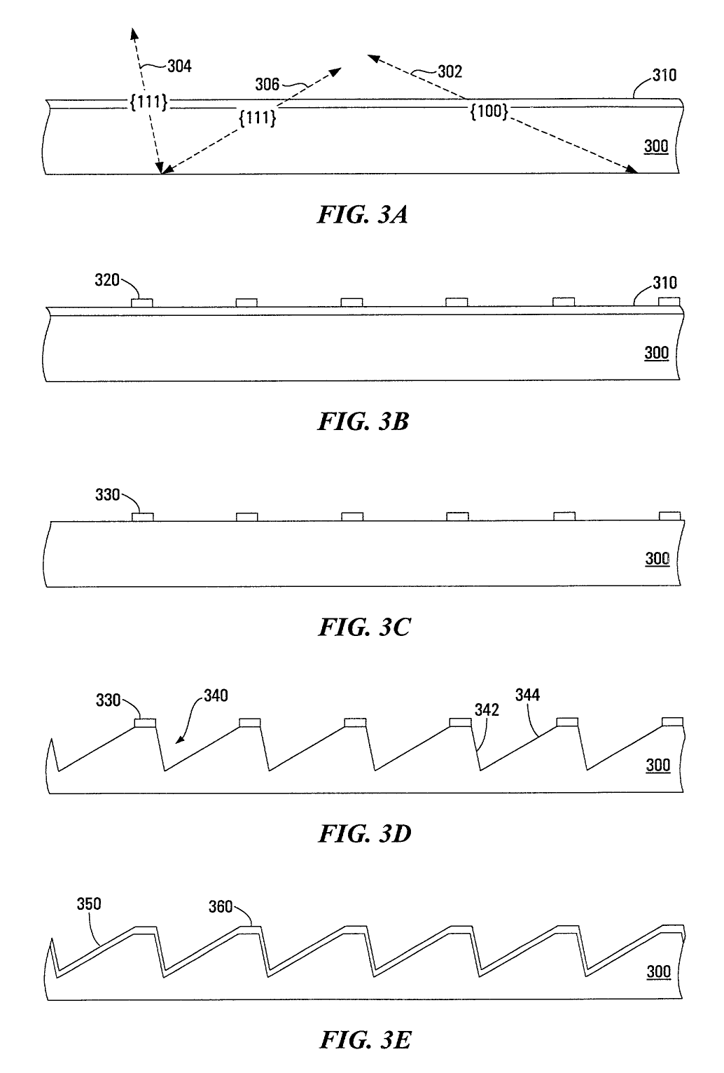

FIG. 3A shows a cross-section of substrate 300 including the location of a {100} plane and two {111} planes as shown by 302, 304, and 306 respectively. Substrate 300 also includes an oxide layer 310. Alignment marks (not shown) are etched into the substrate to determine precisely the crystallographic axes. Note that the alignment marks can be etched following the same general steps as outlined below for the etching of the grating grooves. Those having ordinary skill in the art will readily recognize that there are a variety of photolithographic and micromachining techniques suitable for use in fabricating the disclosed gratings including the alignment marks.

FIG. 3B shows multiple photoresist mask features 320. The photoresist mask features 320 are formed by coating the substrate with a layer of photoresist; selectively exposing the photoresist through a photomask, using, for example, a contact printing technique or direct writing; developing the photoresist; and curing the photoresist (e.g. baking) as necessary. The photomask can be generated, for example, by e-beam and have a plurality of parallel stripes. The width of the stripes defines the width of the etching mask, and the pitch of the stripes (i.e. the distance between the beginning edge of one stripe and the beginning edge of the next stripe) relates to the final groove spacing d. For example, the width of the stripes can be approximately 3 μm and the pitch can be approximately 12 μm.

Next, oxide layer 310 is isotropicly etched, and photoresist mask features 320 are removed leaving a plurality of oxide hard mask features 330, as seen in FIG. 3C. FIG. 3D shows the results of anisotropic etching of the substrate 300 such that a {100} plane is etched more rapidly than other crystallographic planes. Multiple grooves 340 are formed, each with facets 342 and 344. In the example shown, both facets are {111} planes, and the angle between the facets is defined by an inherent angle between {111} planes in single crystal silicon. The oxide hard mask features 330 are removed, the substrate is cleaned, and a coating of reflective material 350, for example vacuum deposited aluminum which has high reflectance for DUV light, is deposited on the surface of the etched substrate, as shown in FIG. 3E. Protective coatings such as SiO₂, SiN₄, and MgF₂ can be deposited prior to deposition of the reflective coating. Additionally, a variety of different metallic (e.g. chromium and nickel) and dielectric coatings (either single or multiple layers) can be deposited as indicated by the particular application for the diffraction grating. Protective coatings can even be deposited on top of the reflective coating or coatings. Once completed, the remaining portions of substrate 300 can serve as a substrate for mounting purposes. Alternatively, the grating can be attached to another substrate material. By attaching several gratings to the same substrate, a single, larger grating can be achieved.

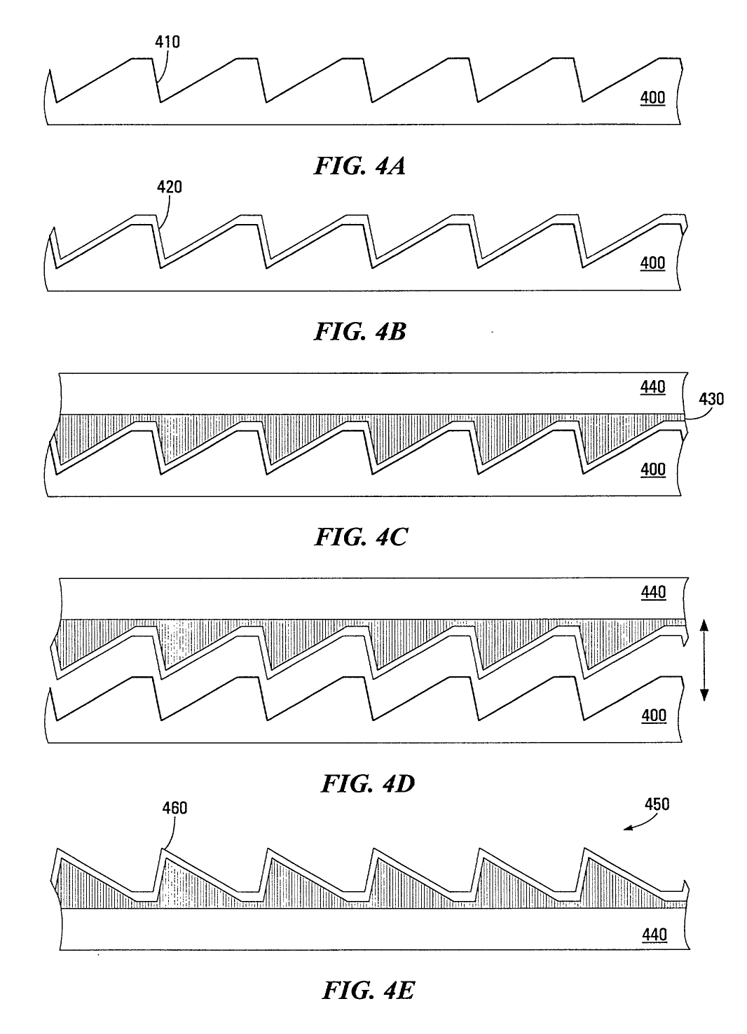

Flats 360 on the top edges between adjacent grooves 340 are caused by the mask used to etch the grooves. Flats 360 are generally undesirable because they prevent incident light from reflecting off a blazed facet such as facet 342. Flats 360 can be reduced and even eliminated in some circumstances by over-etching the silicon and/or minimizing the width of the mask features. Alternatively, the flats can be eliminated by making a replica of the grating, as shown in FIGS. 4A-4E.

The fabrication of a replica grating begins with a master grating such as grating 400. Grating 400 is similar to the grating of FIG. 3E, except that reflective coating 350 has not been deposited, and a thin film of a separating compound 410 has been deposited on the grating. Alternatively, separating compound 410 is deposited on top of reflective coating 350, or in some circumstances, no separating compound is used. FIG. 4B shows that a reflective coating 420 is deposited over the thin film of separating compound. Reflective coating 420 will form the reflective surface of the replica grating. Alternatively, no reflective coating can be deposited at this point in the replication process, and instead a reflective coating can be added after the replica grating is separated from the master grating. Next, the coated master grating 400 is cemented to replica substrate 440 using a layer of resin 430, allowing the resin to polymerize, as shown in FIG. 4C. Replica substrate 440 can be made from glass, such as standard optical glass, BK-7, Pyrex™, ZeroDur™, ULE®, or fused silica. Other materials, such as metal or light-weight composites can also be used. Additionally, a variety of different resins including both polyester and epoxy based resins are suitable for resin 430. FIG. 4D illustrates the separation of the master grating from the replica once resin 430 is sufficiently set. Because of the separation layer and the resin, reflective coating 420 remains attached to the replica grating 450. Because the facets meet at the bottom of each groove in the master grating, the top edge 460 between grooves in the replica grating is generally a sharp edge, and the flats 360 shown in FIG. 3E are eliminated.

Another example of a technique for fabricating replica gratings makes use of compact disc (CD) manufacturing technology. With CDs, the mastering process typically begins with a polished, flat glass master. The master is coated with a layer of photoresist which is then exposed to light from a recording laser. If the photoresist is a positive photoresist, portions of the photoresist that are exposed to light are removed in a subsequent developing step. If the photoresist is a negative photoresist, non-exposed portions of the photoresist layer are removed in a subsequent developing step. Thus, a master is created with either pits or projections representing the binary data recorded on the disk. The master is then coated with a thin layer of metal (e.g. silver and/or nickel). The metalized master is then subjected to an electroforming process where additional metal is added to the thin layer of metal by, for example, electroplating, until a required thickness is achieved. This thick metal layer, often referred to as a “father,” is then separated from the master, and represents a negative image of the master. Because the father is a negative of the master, it can be used as a stamper to replicate CDs directly. Alternatively, the electroforming process can be performed using the father to replicate an additional master or “mother.” The mother, in turn, is used to electroform multiple copies (“sons”) of the stamper needed to produce CDs. Note that the electroforming process can be conducted using a variety of techniques and materials. Additional steps can be included, such as depositing a separation layer between either the master, the father, or the mother and a subsequent electroformed metal layer.

Once a suitable stamper is produced, it is installed in a compression mold or injection mold. Molten plastic, such as polymethylacrylate or polycarbonate, is injected into the mold at high pressure against the stamper. The plastic is then cooled rapidly before the disc is removed. Next, a reflective layer such as aluminum is deposited on the data side of the disk. Finally, a protective layer is deposited over the aluminum.

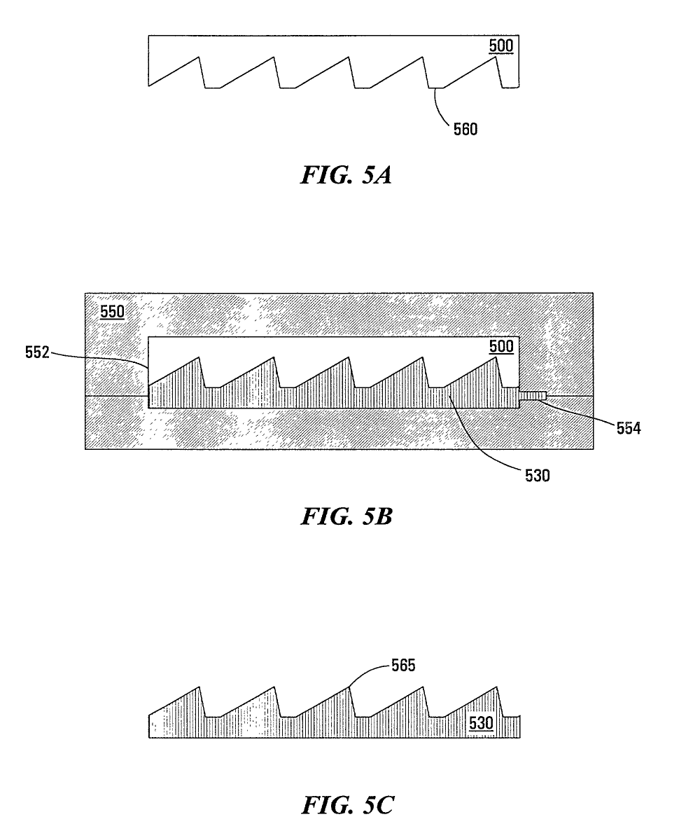

In modifying this process for the fabrication of replica diffraction gratings, the CD glass master is replaced with a master diffraction grating such as grating 500 as shown in FIG. 5A. Grating 500 is similar to the grating of FIG. 3E, except that reflective coating 350 has not been deposited. Grating 500 can be used as the stamper in an injection or compression mold as shown in FIG. 5B. Mold 550 includes a cavity 552 within which grating 500 is placed to serve as the stamper. The remaining space of cavity 552 is filled by way of inlet 554 with plastic, such as polymethylacrylate or polycarbonate, to form replica grating 530. After the plastic cools and hardens, grating 530 is removed from the mold as shown in FIG. 5C. The replica can then be coated with reflective and/or protective materials, and attached to another substrate if desired. Because the facets meet at the bottom of each groove in the master grating, top edge 565 between grooves in the replica grating is generally a sharp edge, and the flats 360 shown in FIG. 3E are eliminated.

As in the case of CD replication, the stamper can be a father, mother, or son that has been electroformed based on the original master diffraction grating. Since one advantage of any replica created from the master diffraction grating described above is a sharp top edge between grooves, a preferred stamper would be an electroformed mother, that is a stamper with the same surface profile as the master grating and formed from a father which is, in turn, formed from the master diffraction grating. Using a mother stamper ensures that the flats 360 are located at the bottom of grooves, and the edges between the grooves are sharp.

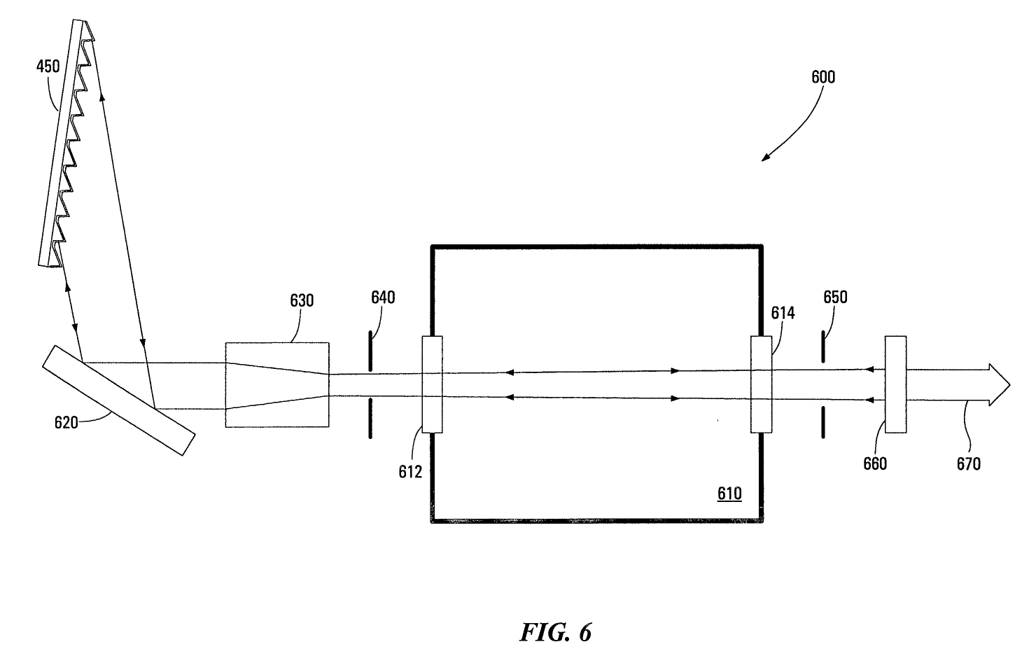

FIG. 6 illustrates an example of an apparatus, in this case a laser, that can use any of the diffraction gratings of the present invention. Spectrally narrowed laser 600, can be based on a variety of different laser technologies including, for example excimer lasers, dye lasers, ion lasers, and solid state lasers, operating in a pulsed or continuous wave (CW) fashion. Gain medium 610 initially produces laser light that is spectrally broad. In the case of an excimer laser, gain medium 610 can be a discharge chamber having windows 612 and 614. The discharge chamber contains a mixture of gases, for example neon, krypton, and fluorine, which become energized by an electrical discharge. The excitation forms an excimer molecule KrF with the necessary population inversion for laser operation, and when lasing does occur, ultraviolet laser light is initially produced in a broad range around 248 nm. Other examples of excimer lasers include argon fluoride (ArF), xenon chloride (XeCl) and xenon fluoride (XeF). The laser light passes through window 612 and aperture 640 where it is expanded by beam expander 630. Beam expander 630 can be constructed from lenses, prisms, or other suitable optical elements. Beam expander 630 expands the width of the laser beam so that the beam has a minimum width, which is then reflected by mirror 620 to a grating such as replica grating 450.

As discussed above, the manner in which the grating is mounted, as well as various grating parameters (e.g. width, blaze angle, reflectance, groove spacing, and diffracted order) determine the light that is reflected back to mirror 620. Thus, only light within a particular narrow band will be reflected by grating 450. Any undesirable wavelengths are reflected back such that they are misaligned with the gain medium, for example they are not reflected by mirror 620, or they are excluded by aperture 640.

Laser light returning to gain medium 610 is amplified through the stimulated emission process, and passes through window 614 and aperture 650 to mirror 660. Mirror 660 is partially reflective so that a percentage of the laser light passes through (e.g. 90%) and the remaining portion of the light is reflected back into the gain medium for further amplification and spectral narrowing. Using this spectral narrowing technique including large, high quality diffraction gratings having carefully formed blazing angles and defect free reflective surfaces such as grating 450, KrF excimer lasers having broad gain profiles of several hundred to 1000 pm can be spectrally narrowed to line widths of approximately 1-3 pm. Those having ordinary skill in the art will readily recognize that the gratings of the present invention can be used in a variety of different optical systems having a light source and requiring some form of spectral narrowing or separation, including laser systems, spectrometers, and wavemeters.

Although the master diffraction grating of the present invention is shown fabricated from silicon, a number of different single crystal materials can be used, including, for example, gallium arsenide (GaAs). Additionally, a variety of different wet and dry etchants can be used to achieve the desired preferential etching leading to specific grating features given the material being etched, the orientation of the material's crystallographic planes, and the orientation of the surface of the grating substrate.

The description of the invention set forth herein is illustrative and is not intended to limit the scope of the invention as set forth in the following claims. Variations and modifications of the embodiments disclosed herein may be made based on the description set forth herein, without departing from the scope and spirit of the invention as set forth in the following claims.

What is claimed is:

1. An echelle comprising:
a single crystal substrate having a surface; and
a plurality of substantially parallel grooves formed in the substrate, each groove including:
a first facet substantially coplanar with a first crystallographic plane of the substrate; and
a second facet aparallel to the first facet and substantially coplanar with a second crystallographic plane of the substrate,
the diffraction grating having a blaze angle defined by the surface of the substrate and the first facet.

2. The diffraction grating of claim 1 further comprising a thin film reflective coating.

3. The diffraction grating of claim 2 wherein the thin film reflective coating is aluminum.

4. The diffraction grating of claim 1 wherein the substrate is silicon and the first crystallographic plane is a {111} plane.

5. The diffraction grating of claim A4 wherein the blaze angle is approximately 78°.

6. A replica diffraction grating comprising:
a substrate; and
a resin layer disposed on a surface of the substrate, the resin layer including a first plurality of substantially parallel grooves formed by contact with a master diffraction grating, the master diffraction grating including:
a single crystal substrate having a surface; and
a second plurality of substantially parallel grooves formed in the single crystal substrate, each groove including:
a first facet substantially coplanar with a first crystallographic plane of the substrate; and
a second facet aparallel to the first facet and substantially coplanar with a second crystallographic plane of the substrate,
the master diffraction grating having a blaze angle defined by the angle between the surface of the single crystal substrate and the first facet.

7. The replica diffraction grating of claim 6 further comprising a thin film reflective coating overlying the resin layer.

8. The replica diffraction grating of claim 6 wherein the resin is selected from a polyester resin and an epoxy resin.

9. The replica diffraction grating of claim 6 wherein the single crystal substrate of the master diffraction grating is silicon and the first crystallographic plane is a {111} plane.

10. The replica diffraction grating of claim 6 wherein the blaze angle is approximately 78°.

11. A method of fabricating a diffraction grating comprising:
providing a single crystal substrate including a top surface, the top surface oriented with respect to a first crystallographic plane of the substrate so as to define a blaze angle therebetween;
depositing a photoresist layer on the substrate;
exposing and developing the photoresist layer to form a plurality of substantially parallel mask features;
preferentially etching the substrate with a first etchant along a third crystallographic plane to form a plurality of grooves, each groove formed between two adjacent mask features and having a first facet and a second facet, the first facet being substantially coplanar with the first crystallographic plane and the second facet being substantially coplanar with a second crystallographic plane; and
removing the mask features.

12. The method of claim 11 further comprising:
forming an alignment mark in the substrate, the alignment mark determining at least one crystallographic axis.

13. The method of claim 12 wherein the single crystal substrate includes an oxide layer formed along the top surface, and wherein the exposing and developing further comprises:
aligning a photomask having a plurality of substantially parallel lines to the alignment mark;
exposing the photoresist through the photomask;
developing the photoresist layer to form a plurality of substantially parallel photoresist lines; and
etching away exposed portions of the oxide layer with a second etchant to form the plurality of mask features from the oxide layer.

14. The method of claim 13 wherein the first etchant and the second etchants are wet etchants.

15. The method of claim 14 wherein the single crystal substrate is silicon, the first etchant includes potassium hydroxide, and the second etchant includes hydrofluoric acid.

16. The method of claim 11 further comprising depositing a reflective coating on the facets of the plurality of grooves.

17. The method of claim 16 wherein the reflective coating is aluminum.

18. The method of claim 11 wherein the mask features are removed during the etching of the substrate with the first etchant.

19. A method of fabricating a replica diffraction grating comprising:
providing a master diffraction grating including:
a single crystal substrate having a surface; and
a plurality of substantially parallel grooves formed in the substrate, each groove including:
a first facet substantially coplanar with a first crystallographic plane of the substrate; and
a second facet aparallel to the first facet and substantially coplanar with a second crystallographic plane of the substrate,
the master diffraction grating having a blaze angle defined by the angle between the surface of the substrate and the first facet;
coating the master diffraction grating with a resin layer;
bonding a replica substrate to the resin layer; and
separating the master diffraction grating from the resin layer and substrate.

20. The method of claim 19 further comprising:
coating the master diffraction grating with a reflective layer capable of bonding to the resin layer.

21. The method of claim 20 wherein the reflective layer is aluminum.

22. The method of claim 19 further comprising coating the master diffraction grating with a thin film of a separating material.

23. The method of claim 22 wherein the separating material is selected from gold, an oil, and a silane.

24. The method of claim 19 wherein the resin is selected from a polyester resin and an epoxy resin.

25. The method of claim 19 wherein the substrate is silicon and the first crystallographic plane is a {111} plane.

26. An apparatus comprising:
a light source; and
a replica diffraction grating located to receive light from the light source and reflect a particular range of wavelengths of the light from the light source, the replica diffraction grating including:
a substrate; and
a resin layer disposed on a surface of the substrate, the resin layer including a first plurality of substantially parallel grooves formed by contact with a master diffraction grating, the master diffraction grating including:
a single crystal substrate having a surface; and
a second plurality of substantially parallel grooves formed in the single crystal substrate, each groove including:
a first facet substantially coplanar with a first crystallographic plane of the substrate; and
a second facet aparallel to the first facet and substantially coplanar with a second crystallographic plane of the substrate,
the master diffraction grating having a blaze angle defined by the angle between the surface of the single crystal substrate and the first facet.

27. The apparatus of claim 26 wherein the light source is a laser including a gain medium, and the replica diffraction grating reflects the particular range of wavelengths of the light from the laser back into the gain medium.

28. The apparatus of claim 27 further comprising a beam expander located between the laser and the replica diffraction grating.

29. The apparatus of claim 26 wherein the light source includes light to be analyzed, and the replica diffraction grating reflects the particular range of wavelengths of the light from the light source to a detector.

30. An apparatus comprising:
a light source; and
an echelle located to receive light from the light source and reflect a particular range of wavelengths of the light from the light source, the echelle including:
a single crystal substrate having a surface; and
a plurality of substantially parallel grooves formed in the substrate, each groove including:
a first facet substantially coplanar with a first crystallographic plane of the substrate; and
a second facet aparallel to the first facet and substantially coplanar with a second crystallographic plane of the substrate,
the diffraction grating having a blaze angle defined by the surface of the substrate and the first facet.

31. The apparatus of claim 30 wherein the light source is a laser including a gain medium, and the echelle reflects the particular range of wavelengths of the light from the laser back into the gain medium.

32. The apparatus of claim 31 further comprising a beam expander located between the laser and the echelle.

33. The apparatus of claim 30 wherein the light source includes light to be analyzed, and the echelle reflects the particular range of wavelengths of the light from the light source to a detector.

34. A method of fabricating a replica diffraction grating comprising:
forming a stamper with a grating surface from a master diffraction grating including:
a single crystal substrate having a surface; and
a plurality of substantially parallel grooves formed in the substrate, each groove including:
a first facet substantially coplanar with a first crystallographic plane of the substrate; and
a second facet aparallel to the first facet and substantially coplanar with a second crystallographic plane of the substrate,
the master diffraction grating having a blaze angle defined by the angle between the surface of the substrate and the first facet;
disposing the stamper in a mold such that the grating surface is an inner surface of the mold;
filling the mold with a liquid plastic; and
removing a molded replica diffraction grating from the stamper.

35. The method of claim 34 wherein forming a stamper further comprises:
coating the master diffraction grating with a thin metal layer; and
electroforming the stamper on the thin metal layer.

36. The method of claim 34 wherein forming a stamper further comprises:
coating the master diffraction grating with a thin metal layer;
electroforming a father on the thin metal layer;
separating the father from the master grating; and
electroforming the stamper on the father.

37. The method of claim 34 further comprising coating the replica diffraction grating with a reflective layer.

38. The method of claim 37 wherein the reflective layer is aluminum.

39. The method of claim 34 wherein the plastic is selected from polycarbonate and polymethylacrylate.

40. The method of claim 34 wherein the substrate is silicon and the first crystallographic plane is a {111} plane.
